(19) United States
(12) Patent Application Publication
(10) Pub. No.: US 2003/0008047 A1
(43) Pub. Date: Jan. 9, 2003

(54) Stability enhancement of sweeteners using salts containing divalent or trivalent cations

(76) Inventors: Steve A. Schroeder, Belvidere, IL (US); Run Wang, Gurnee, IL (US)

Correspondence Address: JEFFREY M. HOSTER, c/o THE NUTRASWEET COMPANY, 10 S. WACKER DRIVE, SUITE 3200, CHICAGO, IL, 60606, US

(21) Appl. No.: 09/527,613

(22) Filed: Mar. 17, 2000

(51) Int. Cl. A23L 1/236

(52) U.S. Cl. 426/548

(57) ABSTRACT

Compositions comprising the sweetener N-[N-(3,3-dimethylbutyl)-L-α-aspartyl]-L-phenylalanine 1-methyl ester sweetener (“neotame”), or L-aspartyl-L-phenylalanine sweetener (“aspartame”), and at least one divalent cation, trivalent cation or mixture thereof are disclosed. Divalent and trivalent cations enhance the stability of neotame and aspartame in edible compositions, including cola-type soft drinks and syrups.

### BACKGROUND OF THE INVENTION

1. Field of the Invention

This invention relates to the use of salts containing divalent or trivalent cations to enhance the stability of N-[N-(3,3-dimethylbutyl)-L-α-aspartyl]-L-phenylalanine 1-methyl ester (hereinafter also referred to as “neotame”) and L-aspartyl-L-phenylalanine (hereinafter also referred to as “aspartame”) in sweetened compositions.

2. Description of the Prior Art

Since the introduction of sweeteners such as saccharin and cyclamates as replacements for caloric sweeteners in the 1950s and 1960s, the market for products containing sweeteners other than sugars has grown substantially. This growth can be traced to the success of the sweetener aspartame, a sweetener having a potency upward of 200 times that of sucrose. The success of aspartame can be traced to many factors, including the fact that aspartame is chemically the methyl ester of a dipeptide comprised of two naturally occurring amino acids.

Other high-potency sweeteners have been suggested for use in beverages, for example acesulfame-K, sucralose, and alitame. However, while these sweeteners have significant potency as compared to sucrose or high fructose corn syrup, when used alone, taste and other concerns have kept them from being successfully and broadly used in beverages.

Attempts have been made to improve the taste properties of these sweeteners. These attempts have included blends of conventionally available sweeteners like aspartame with saccharin, as disclosed in U.S. Pat. No. 3,780,189, and aspartame with acesulfame-K, as disclosed in U.S. Pat. No. 4,158,068. These patents assert that the resulting sweetener combinations have a more sucrose-like taste and/or potency synergy, the later of which may result in overall cost reduction.

The N-alkylated aspartame derivative, N-[N-(3,3-dimethylbutyl)-L-α-aspartyl]-L-phenylalanine methyl ester (neotame) is known to be an extremely potent sweetening agent, as disclosed in U.S. Pat. No. 5,480,668, the complete disclosure of which is incorporated by reference herein. Its sweetening potency, on a weight basis, is at least 40 times that of aspartame and about 8,000 times that of sucrose.

Since neotame is such a highly potent sweetener, it would be advantageous to be able to utilize it in a wide variety of edible compositions. It would also be advantageous to utilize aspartame (which is already utilized in edible compositions) more effectively. Specifically, it would be desirable to increase the stability of neotame and aspartame in edible compositions.

It is of particular interest to be able to utilize neotame in beverage compositions containing caramel coloring and having a pH in the range of 2.9 to 3.5, i.e. in cola-type soft drinks.

### SUMMARY OF THE INVENTION

This invention relates to a composition comprising, N-[N-(3,3-dimethylbutyl)-L-α-aspartyl]-L-phenylalanine 1-methyl ester sweetener or L-aspartyl-L-phenylalanine sweetener, and at least one divalent cation, trivalent cation, or mixture thereof, in an amount effective to enhance the stability of the sweetener in the composition.

This invention also relates to beverage and beverage syrup compositions comprising N-[N-(3,3-dimethylbutyl)-L-α-aspartyl]-L-phenylalanine 1-methyl ester sweetener or L-aspartyl-L-phenylalanine sweetener, caramel coloring, water, at least one divalent cation, trivalent cation, or mixture thereof, in an amount effective to enhance the stability of the sweetener in the beverage or beverage syrup composition.

It has been found by the inventors herein that the addition of certain food grade metal salts containing divalent or trivalent cations enhances the stability of neotame- and aspartame-containing compositions in a variety of environments, including cola-type soft drinks.

### DETAILED DESCRIPTION OF THE PREFERRED EMBODIMENTS

This invention is related to compositions that are sweetened by the addition of neotame or aspartame, and which contain a divalent cation, a trivalent cation, or a mixture thereof, to enhance the stability of the sweetener.

The stability of neotame and aspartame can be enhanced in a wide range of edible compositions, including, but not limited to: beverages, chewing gum, pharmaceuticals, confections, cereals, dairy products, gelled products, bakery products, and personal care products.

In preferred embodiments, the stability-enhanced composition according to the invention is a soft drink. In particularly preferred embodiments, the stability enhanced composition is a cola-type soft drink.

Neotame and aspartame have been found to have the desired combination of extremely high potency compared to sucrose while having a clean, sweet taste like that of sucrose in beverages. However, over time, these sweeteners break down causing a loss of sweetness. The interaction of other components with neotame and aspartame causes breakdown of these sweeteners either by direct interaction, or by causing self-degradation of the sweetener.

For example (without intending to be bound by theory), it is believed that in compositions containing caramel coloring and having a pH in the range of about 2.0 to about 3.5 (which generally includes both cola-type soft drinks and syrups), the caramel coloring interacts with neotame or aspartame. Without being bound to theory, it is believed that the caramel coloring may complex with the sweetener and cause hydrolysis. Therefore, to use neotame or aspartame more effectively in these beverage compositions, it is believed that it would be advantageous to prevent this undesired hydrolysis.

It is further believed that undesired hydrolysis is prevented by the addition of food grade-metal salts containing divalent and/or trivalent cations to the beverage composition, which apparently interferes with the hydrolysis.

Exemplary divalent cations that may be used to enhance the stability of neotame and aspartame include, without limitation magnesium, calcium, and iron (II). The divalent cations may be used singularly or in combination with one or more divalent cations or in combination with one or more trivalent cations. Exemplary trivalent cations that may be used to enhance the stability of neotame and aspartame include, without limitation, aluminum and iron (III). The trivalent cations may be used singularly or in combination with one or more trivalent cations or in combination with one or more divalent cations.

The source of these cations can be from any salts that contain divalent or trivalent cations. Of course the salts must be acceptable for use in an edible composition. These salts include, for example, phosphates, phosphites, sulphites, sulphates, hydroxides, chlorides and hydrates of any of these. Non-limiting examples include CaCl₂.2H₂O, MgCl₂.6H₂O, MgSO₄, FeCl₂, AlCl₃, or FeCl₃.

Particularly preferred salts for use with the present invention are the food grade salts CaCl₂.2H₂O and MgCl₂.6H₂O.

Generally, the amount of neotame employed in a composition according to the invention will be guided by the sweetness desired in view of compositions conventionally sweetened with sucrose, high fructose corn syrup, or high intensity sweeteners such as aspartame. For example, neotame may be added to soft drink beverages in an amount between about 2 ppm to about 150 ppm, preferably in an amount between about 10 ppm to 50 ppm, and most preferably in an amount between about 15 ppm to about 30 ppm. Of course relatively greater concentrations would be used in a syrup depending on the dilution factor or “throw” of the syrup.

The amount of aspartame utilized in an edible composition will be governed by the same considerations. For example, aspartame may be added to soft drink beverages in an amount between about 275 ppm and about 625 ppm, preferably, between about 350 ppm and about 550 ppm.

To enhance the stability of the appropriate amount of neotame or aspartame in a beverage composition, a food grade metal salt, containing a divalent or trivalent cation or a mixture of food grade metal salts containing a divalent cation, a trivalent cation, or a mixture thereof, is added. The effective amount of cation added is dependent upon the cation used. The cation is added so that it adequately complexes with the component capable of causing hydrolysis of neotame or aspartame, such as caramel coloring, to thereby increase the stability of neotame or aspartame.

Divalent cations may be effective to enhance stability in a beverage in an amount of approximately 5 ppm to approximately 100 ppm. When used alone, trivalent cations may be used in an amount of approximately 5 ppm to approximately 30 ppm. Again, one skilled in the art could readily determine the concentration to be used in syrups based on expected dilution factors. In general, once the stability-enhancing effect is obtained in a composition by addition of divalent or trivalent cations, increasing the level of cations greatly in excess of the effective amount will not produce a commensurate increase in stability.

A preferred combination of divalent cations is Mg²⁺ and Ca²⁺. When used in combination, it is preferred that Mg²⁺ be present in the beverage in an amount of approximately 5 ppm to 10 ppm, and Ca²⁺ be present in the beverage in an amount of approximately 25 ppm to 30 ppm. In a particularly preferred embodiment, Mg²⁺ is present in an amount of approximately 7 ppm and Ca²⁺ is present in an amount of approximately 27 ppm in a beverage composition.

With trivalent cations, less cation is required to obtain a stability enhancing effect. However, care must be taken that the trivalent cations do not precipitate out other components (such as the caramel coloring in a cola-type beverage composition).

It will be appreciated by one of ordinary skill in the art that the selection of an appropriate food grade salt will also be guided by the nature of the anion. Even at the relatively low levels of salt employed, some anions may have an undesired effect on taste or consistency of the stabilized edible product.

The percentage of enhancement of the stability of neotame is dependent upon storage time and temperature. For example, the percent enhancement of stability of neotame in cola-type soft drinks may range from about 57% to about 190%, as measured by the half-life of the sweetener in the composition, again, depending on the storage time and temperature.

The food grade metal salts containing divalent or trivalent cations may be mixed with the neotame as a means to deliver the neotame to carbonated beverages. Alternatively, the food grade metal salts may be added to beverage syrup compositions. Beverage syrups according to the invention contain caramel coloring, and in preferred embodiments have a pH in the range of about 2.0 to about 2.7. These syrups are used to make cola-type soft drinks.

The amount of neotame utilized in a syrup generally ranges between about 100 and 150 ppm. Aspartame is generally used in a syrup in an amount between about 2500 ppm and 4000 ppm.

The invention can be understood more readily by referring to the Examples set forth below. The Examples which follow are intended as an illustration of certain preferred embodiments of the invention and are not intended to limit the invention set forth in the claims.

### EXAMPLE 1

Sample Preparation

Use-level cola-type soft drinks were prepared by dilution of one volume of cola syrup with 5 volumes of water filtered using a Millipure Milli-Q™ system. The syrups used had the composition shown in Cola Formulations 1 and 2 below. Suitable cola acids, known in the art, include citric and phosphoric acids. The components of cola flavor generally include citrus oils (lime, lemon, orange), cassia oil, nutmeg oil, ginger oil, and caramel coloring. Also, kola nut extract and vanilla may be used.

Cola Formulation 1

| Ingredients | Amount |
|---|---|
| Sodium Benzoate | 1.2 g |
| Cola Acid* | 3.2 g |
| Cola Flavor** | 17.2 g |
| Water | added to 1000 mL |

*A combination of caramel coloring, phosphoric acid and caffeine available from Universal Flavors, Indianapolis, Indiana.
**A combination of caramel coloring and various cola flavor ingredients available from Universal Flavors, Indianapolis, Indiana.

Cola Formulation 2

| Ingredients | Amount (g) |
|---|---|
| Caffeine Anhydrous | 0.599 |
| Potassium Benzoate | 1.406 |
| Cola Flavor | 11.341 |
| Cola Acid | 2.648 |
| Water | added to 1000 mL |

Neotame was added to the above formulas in an amount of approximately 20 ppm to obtain neotame-sweetened cola-type soft drinks.

Approximately 27 ppm of Ca²⁺ ions and approximately 7 ppm of Mg²⁺ ions were added to samples of the neotame sweetened cola-type soft drinks to obtain cation-stabilized neotame-containing soft drinks. Food-grade CaCl₂.2H₂O was used as the Ca²⁺ source, and either MgCl₂.6H₂O or MgSO₄ was used as the Mg²⁺ source.

Stability Analysis

A stability analysis was carried out on the use-level cola-type soft drink samples containing neotame. These samples contained approximately 20 ppm neotame at time zero. All stability samples prepared were pH adjusted to 3.10±0.05 before placing them into an environmental cabinet with proper temperature control at temperatures of 4° C., 20° C., 35° C., 45° C., and 55° C., respectively.

Samples were pulled from the environmental cabinets at pre-determined time periods for high performance liquid chromatography (HPLC) analysis. At least four data points were recorded for determining the half life of neotame in the cola-type soft drink formula at 4° C., 20° C., 35° C., 45° C., and 55° C.

The length of the stability study or the storage time for the last pull point varied depending on specific temperatures. In general, the lower the temperature, the longer storage time for the last pull point.

HPLC analysis was used to determine the concentration of neotame in the stability samples. Quantification of neotame was based on a three-point working curve. The concentrations of neotame standards were 2, 10, and 50 ppm in 10% methanol/90% H₂O. Below are the HPLC conditions used:

| | |
|---|---|
| Column | Ultrasphere Octyl 250 × |
| | 4.6 mm |
| Column Temperature | 40° C. |
| Mobile Phase | 30% v/v ACN/70% 0.18 M |
| | NaH₂PO₄, 0.02 M |
| | heptanesulfonic acid, pH |
| | 2.50 ± 0.05 |
| Flow Rate | 1.5 mL/min. |
| Injection Volume | 25 μL |
| Run Time | Approximately 30 minutes |
| Autosampler Temperature | 0-10° C. |

Determination of Half Life

The percent remaining of neotame at each pull point in the HPLC analysis was calculated using the equation given below:

% Remaining Neotame=[Neotame]_{time t}/[Neotame]_{time zero}×100%

where the [Neotame]_{time t} is the concentration of neotame in the stability samples after the samples have been stored for a period of time, and the [Neotame]_{time zero} is the concentration of neotame in the stability samples at time zero.

The percent remaining was then fit to a first order kinetic rate equation described below:

% Remaining of Neotame=100% e^{-kt}

and the k value was determined by the best fit and used to calculate the half life.

Table 1 summarizes the stability results of the cola-type soft drinks of Cola Formulation 1 and Cola Formulation 2.

TABLE 1

| | | Half life (days) | | | | |
|---|---|---|---|---|---|---|
| Systems | Description | 4° C. | 20° C. | 35° C. | 45° C. | 55° C. |
| Cola | w/o Ca²⁺ and | 490 | 110 | 27 | 16 | 7.0 |
| Formulation | Mg²⁺ | | | | | |
| 1 | w/ Ca²⁺ and | 1100 | 240 | 57 | 27 | 11 |
| | Mg²⁺ | | | | | |
| | % Enhance- | 120 | 120 | 110 | 69 | 57 |
| | ment | | | | | |
| Cola | w/o Ca²⁺ and | 450 | 100 | 27 | 17 | 7.5 |
| Formulation | Mg²⁺ | | | | | |
| 2 | w/ Ca²⁺ and | 1100 | 290 | 60 | 30 | 13 |
| | Mg²⁺ | | | | | |
| | % Enhance- | 140 | 190 | 120 | 76 | 73 |
| | ment | | | | | |

These results show that the percent enhancement of stability of neotame in a cola beverage, as measured by the half-life ranges between 57% and 190% due to addition of Ca²⁺ and Mg²⁺ to the beverages.

The stability enhancement appears higher at lower temperatures compared to that at higher temperatures. For example, at 20° C. the percent enhancement in Formula 1 is 120%, but at 55° C. the percent enhancement is 57%.

### EXAMPLE 2

This example shows the stability enhancement of aspartame at varying levels of added cations. Samples of Cola Formulation 1 were prepared, pH adjusted to pH 2.5, and sweetened with aspartame. Varying amounts of Mg²⁺ and Ca²⁺ cations were added to different samples, as set forth in Table 2. The stability of the aspartame over time in the different samples at a storage temperature of 35° was measured substantially as described above. The results, tabulated below, show and improvement in the half life of between 33 and 45% for the aspartame-sweetened compositions that were stabilized with cations.

TABLE 2

| Ca²⁺ | Mg²⁺ | Half life (days) |
|---|---|---|
| 0 | 0 | 45 |
| 23 | 40 | 60 |
| 12 | 20 | 59 |
| 80 | 40 | 65 |
| 8 | 20 | 63 |
| 48 | 30 | 62 |

### EXAMPLE 3

Samples were prepared, pH adjusted to pH 3.1, and stored substantially in accordance with the samples of Example 1, except that aspartame, in a concentration of approximately 525 ppm, was used as the sweetener instead of neotame. The results are tabulated in Table 3 below.

TABLE 3

| | | Half life (days) | | | |
|---|---|---|---|---|---|
| Systems | Description | 20° C. | 35° C. | 45° C. | 55° C. |
| Cola | w/o Ca²⁺ and Mg²⁺ | 180 | 44 | 19 | 7 |
| Formulation | w/ Ca²⁺ and Mg²⁺ | 210 | 53 | 22 | 8 |
| 1 | % Enhancement | 17 | 20 | 16 | 14 |
| Cola | w/o Ca²⁺ and Mg²⁺ | 200 | 45 | 21 | 7 |
| Formulation | w/ Ca²⁺ and Mg²⁺ | 230 | 54 | 24 | 8 |
| 2 | % Enhancement | 15 | 20 | 14 | 14 |

The observed stability enhancement of aspartame-sweetened compositions using cations is substantial, although less dramatic than that obtained for neotame under the same conditions.

The stability enhancement of neotame and aspartame using cations has been demonstrated with cola-type soft drinks. However, no limitation of the invention is intended thereby. The scope of the invention is set forth in the claims that follow. Moreover, the full scope of the invention includes obvious variations and modifications of the subject matter disclosed herein that would occur to one of ordinary skill in the art.

What is claimed is:

1. A composition comprising:
(a) N-[N-(3,3-dimethylbutyl)-L-α-aspartyl]-L-phenylalanine 1-methyl ester sweetener, or L-aspartyl-L-phenylalanine sweetener, and
(b) at least one divalent cation, trivalent cation, or mixture thereof, in an amount effective to enhance the stability of the sweetener.

2. A composition according to claim 1, wherein said sweetener consists essentially of N-[N-(3,3-dimethylbutyl)-L-α-aspartyl]-L-phenylalanine 1-methyl ester sweetener.

3. The composition according to claim 1 wherein said composition is a beverage and further comprises caramel coloring.

4. The composition according to claim 1, wherein said at least one cation is selected from the group consisting of calcium, magnesium, aluminum, iron (II), iron (III), and mixtures thereof.

5. The composition according to claim 4, wherein the source of said cation is a food grade metal salt having an anion selected from the group consisting of sulphites, sulphates, phosphites, phosphates, hydroxides, chlorides, and hydrates thereof.

6. The composition according to claim 6, wherein said food grade metal salt is selected from the group consisting of MgCl₂.6H₂O and CaCl₂.2H₂O, and mixtures thereof.

7. The composition according to claim 3, wherein N-[N-(3,3-dimethylbutyl)-L-α-aspartyl]-L-phenylalanine 1-methyl ester sweetener is present in said beverage in an amount between about 2 ppm to about 150 ppm.

8. The composition according to claim 7, wherein said at least one cation comprises a divalent cation present in an amount between about 5 ppm to about 100 ppm.

9. The composition according to claim 7, wherein said at least one cation comprises a trivalent cation present in an amount between about 5 ppm to about 30 ppm.

10. The composition according to claim 7, wherein said at least one cation is a mixture of cations comprising Mg²⁺ and Ca²⁺.

11. The composition according to claim 9, wherein said Mg²⁺ is present in an amount of about 7 ppm and said Ca²⁺ is present in an amount of approximately 27 ppm.

12. The composition according to claim 3, wherein said beverage has a pH in the range of 2.9 to 3.5.

13. The composition of claim 1 wherein said composition is a cola soft drink syrup and comprises caramel coloring.

14. The composition according to claim 13, wherein said cation is selected from the group consisting of calcium, magnesium and mixtures thereof.

15. The composition according to claim 13, wherein said syrup has a pH in the range of 2.0 to 2.7.

16. The composition of claim 1, wherein said composition is a beverage and said sweetener consists essentially of L-aspartyl-L-phenylalanine sweetener in an amount between about 275 ppm and about 625 ppm.

17. A cola soft drink comprising:
(a) N-[N-(3,3-dimethylbutyl)-L-α-aspartyl]-L-phenylalanine 1-methyl ester,
(b) a divalent cation or a mixture of divalent cations from one or more food grade metal salts,
(c) caramel coloring,
(d) carbonated water,
(e) sodium benzoate,
(f) cola acid, and
(g) cola flavor.

18. A method for enhancing the stability of edible compositions comprising the steps of, adding to a composition containing N-[N-(3,3-dimethylbutyl)-L-α-aspartyl]-L-phenylalanine 1-methyl ester sweetener or L-aspartyl-L-phenylalanine sweetener, at least one divalent cation, trivalent cation or mixture thereof, in an amount effective to increase the half life of said sweetener in said composition.

19. The method of claim 18, wherein said divalent cation, trivalent cation or mixture thereof comprises a divalent cation in amount between about 5 ppm and about 100 ppm.

20. The method of claim 18, wherein said divalent cation, trivalent cation or mixture thereof comprises a trivalent cation in amount between about 5 ppm and about 30 ppm.

21. The method of claim 18, wherein said sweetener is N-[N-(3,3-dimethylbutyl)-L-α-aspartyl]-L-phenylalanine 1-methyl ester sweetener.
